(19) United States
(12) Patent Application Publication
(10) Pub. No.: US 2018/0372275 A1
(43) Pub. Date: Dec. 27, 2018

(54) Cover For Gas Cylinder Tap With Removable Front Area

(71) Applicant: Luxembourg Patent Company S.A., Lintgen (LU)

(72) Inventors: Morgan Lamiable, Metzervisse (FR); Jean-Claude Schmitz, Heisdorf (LU)

(21) Appl. No.: 15/776,695

(22) PCT Filed: Nov. 14, 2016
(86) PCT No.: PCT/EP2016/077567

§ 371 Date: May 16, 2018

(30) Foreign Application Priority Data
Nov. 16, 2015 (LU) LU92873

(51) Int. Cl. F17C 13/04

(52) U.S. Cl. CPC F17C 13/04; F17C 2201/0104; F17C 2205/0165; F17C 2205/0308; F17C 2205/0329; F17C 2270/0745; F17C 2250/043; F17C 2250/0486; F17C 2250/0626; F17C 2250/0636; F17C 2223/0123

(57) ABSTRACT

A cover for a tap of a gas cylinder, the cover comprising a shell for housing the tap, the shell comprising a front area for an indicator, a wheel for adjusting the outlet pressure and/or flow rate, and/or at least one outlet connector of the tap. The front area of the shell is a part that is distinct from, and configured to be attached to, the rest of the shell.

### CROSS-REFERENCE TO RELATED APPLICATIONS

The present invention is the US national stage under 35 U.S.C. § 371 of International Application No. PCT/EP2016/077567, which was filed on Nov. 14, 2016, and which claims the priority of application LU 92873 filed on Nov. 16, 2015, the content of which (text, drawings and claims) are incorporated here by reference in its entirety.

### FIELD

The invention is directed to the field of taps for gas cylinder and of covers for such taps. More specifically the invention is directed to a cover for a tap of a gas cylinder as well as to a tap assembly comprising a tap and a cover.

### BACKGROUND

Prior art patent document published EP 2 586 481 A1 discloses a cover for a tap of a gas cylinder. The cover is made of two half-shells that are joined on a vertical contact plane comprising the longitudinal axis of the cylinder. A hook is pivotally mounted on the cover and is intended to hang the gas cylinder to a structure while in use. The hook is mounted so as to freely hang downwards and contact the cylinder when not in use. Also the cover comprises potentially sharp angles at the joining surfaces. The cover is also configured to be fixed to the tap after mounting said tap on the cylinder, thereby leading to time consuming operations.

Prior art patent document published WO 2013/001190 A1 discloses, similarly to the previous document, a protective cover for a tap of a gas cylinder. The cover includes two half-shells assembled together, the two half-shells defining a bottom base to be mounted at the neck of the cylinder, wherein the two half-shells are assembled along a vertical plane perpendicular to the base. The two half shells define, in the assembled position, at least one opening for accessing the inner protective space. It also includes, at a top end of the cap, a part for reinforcing and locking the two half-shells, the reinforcing and locking part including two ends coupled to the two half-shells, respectively. The reinforcing and locking part is generally beam-shaped and is mounted onto a frame formed by the half-shells, the frame covered by the reinforcing part consisting of a top handle for gripping the cap, both ends of the reinforcing and locking part being snap-coupled to the half-shells. A sliding and pivoting hook is provided on the cover. Similarly to the cover of the previously discussed document, the present cover is configured to be attached to the cylinder after having mounted the tap on the cylinder, thereby leading to time consuming operations.

Prior art patent document published WO 2015/132092 A2 discloses a cover for a gas cylinder tap. The cover comprises a shell for housing the tap and a hook pivotally mounted on the shell, the hook being configured for securing the gas cylinder to a horizontal bar, like a bar of a hospital bed. The shell comprises reservations on its external surface configured for receiving the hook in a folded position so as to generally conform to said external surface. The invention is also directed to a gas storage assembly comprising a gas cylinder, a tap and a cover. The shell comprises an upper half-shell and a lower half-shell joined together. The tap comprises a rotatable wheel for actuating a flow selector, said wheel being on the upper half-shell. The tap comprises also an outlet connector of the hose barb type extending through an opening of the upper half-shell.

### SUMMARY

The invention has for technical problem to provide a cover for gas cylinder tap that provides more flexibility and ease of assembly. In particular, for certain applications it can be wished to have a different outlet with a quick connector.

The invention is directed to a cover for a tap of a gas cylinder, the cover comprising a shell for housing the tap, the shell comprising a front area for an indicator, a wheel for adjusting the outlet pressure and/or flow rate, and/or at least one outlet connector of the tap; and wherein the front area of the shell is a part that is distinct from, and configured to be attached to, the rest of the shell.

Advantageously, the shell is generally ball-shaped.

The indicator can be an indicator of the pressure inside the cylinder, the outlet pressure, the outlet flow-rate and/or the remaining service time at the present flow-rate. The indicator can be a mechanic gauge and/or an electronic device with a display. It can be housed at the centre of the adjusting wheel.

According to various embodiments, the shell front area part comprises a first opening for receiving the adjusting wheel and/or the indicator and at least a second opening for receiving the or one of the at least one outlet connector.

According to various embodiments, the average diameter of the first opening is larger than 150%, for example 200%, more for example 300%, of the average diameter of the at least one second opening.

According to various embodiments, the first opening is located above the at least second one when the cover is in a mounting position on the gas cylinder disposed vertically.

According to various embodiments, the shell front area part comprises on its outer surface a marking along the first opening, the marking serving as reference for the adjusting wheel.

According to various embodiments, the shell comprises an upper half-shell and a lower half-shell to be joined to each other, the shell front area part being configured to be located on, and attached to, the upper half-shell.

According to various embodiments, the upper half-shell and the lower half-shell are configured to be joined together along a general contact plane that forms an angle comprised between 30° and 60° with a vertical direction, and the shell front area part is curved and directed towards a main upward direction that forms an angle comprised between 30° and 60° with a vertical direction, when the cover is in a mounting position on the gas cylinder disposed vertically. The contact plane is not necessarily exactly a plane but can be a plane-like extension.

According to various embodiments, the upper half-shell comprises an opening that corresponds essentially to the shell front area part.

According to various embodiments, the upper half-shell comprises a shoulder extending along its opening, the shell front area part being configured for resting on the shoulder.

According to various embodiments, the upper half-shell comprises two arms extending laterally and vertically for holding a handle above the shell, the shell front area part being located between the two lateral arms.

The invention is also directed to a tap assembly for a gas cylinder, comprising: a tap to be screwed on the gas cylinder; and a cover housing the tap; wherein the cover is in various embodiments in accordance with the invention, the cover being rigidly attached to the tap so that the tap assembly forms a unit that can be mounted on the gas cylinder.

According to various embodiments, the tap comprises at least one outlet with a quick connector extending through an opening of the shell front area part, the connector comprising a release ring that forms an annular press-surface complementary to the opening. The front area of the shell must not necessarily be a part that is distinct from, and configured to be attached to, the rest of the shell.

According to various embodiments, the annular press-surface is generally circular over more than 270° and comprises, in addition, a flattened portion, the opening in the shell front area part forming an open contour that is complemented by a portion of the upper half-shell, the flattened portion being against the portion of the upper half-shell.

According to various embodiments, the tap comprises an additional outlet, the outlet comprising a hose barb connector extending through another opening of the shell front area part.

According to various embodiments, the tap comprises a shut-off valve with an actuating knob at a lateral location of the shell. The shut-off valve can comprise an actuation shaft that extends transversely, in various instances along the contact plane between the upper half-shell and the lower half-shell.

The invention is particularly interesting in that it provides a cover with more flexibility with regard to different configurations of the tap housed in the cover while keeping the cover compact and ergonomic. Indeed, different front area parts can be manufactured according to the different configurations of the tap, e.g. the number of outlets, the position of the adjusting wheel, if any, and the position of a status indicator, if any. The remaining parts of the cover, i.e. the upper and lower half-shells, remain the same for different configurations and can be produced at larger scale. It is known that moulds for producing such plastic parts are expensive and that the price increases with the size of the mould. With the present invention, the production costs can be reduced while remaining modular for different configurations. Also, the invention provides a more ergonomic cover with the possibility of having a quick connector at the front area, with a push surface for releasing the connector. The push surface is married with the cover so as to provide a convenient actuation. Quick connectors are usually released by means of a sliding ring that requires room for being gripped and pushed. With the invention, that ring is integrated in the cover so as to form a convenient push surface that extends essentially perpendicularly to the axis of the connector. Also the cover remains compact.

### DRAWINGS

FIG. 1 is a perspective view of a tap assembly with a cover in accordance with various embodiments of the invention.

FIG. 2 is a perspective view of the upper half-shell and a shell front area part of the cover FIG. 1, in accordance with various embodiments of the invention.

FIG. 3 is a perspective view of a tap assembly with a cover in accordance with various other embodiments of the invention.

FIG. 4 is a front view of the tap assembly of FIG. 3, in accordance with various embodiments of the invention.

FIG. 5 is a perspective view of the upper half-shell and a shell front area part of the cover of FIGS. 3 and 4, in accordance with various embodiments of the invention.

### DESCRIPTION

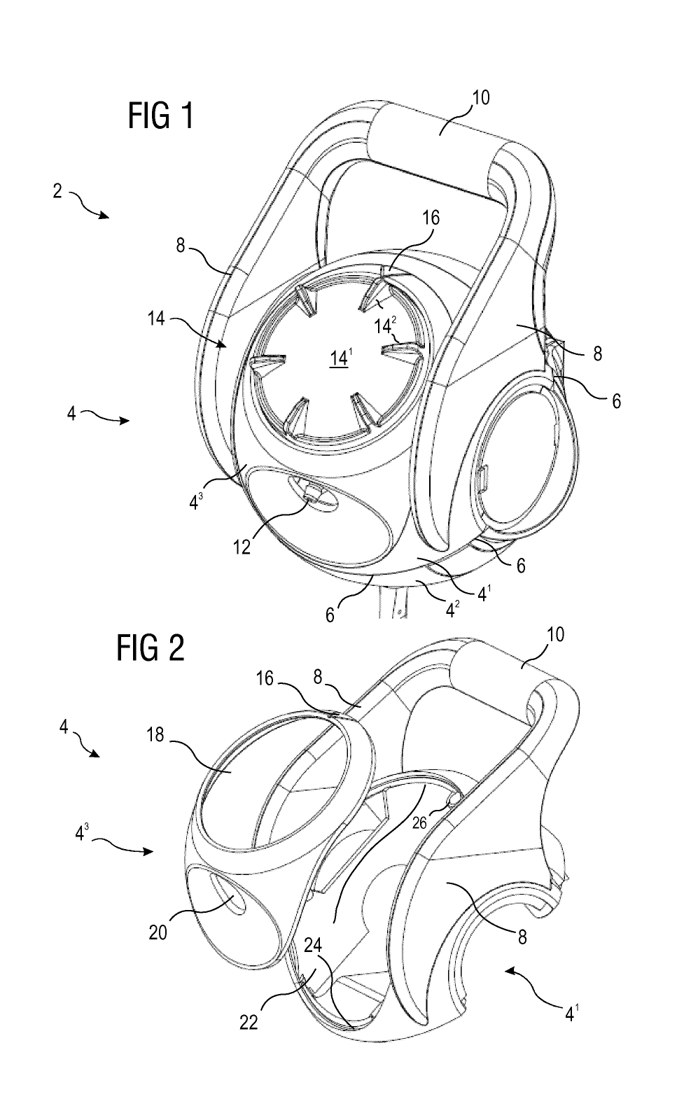

FIGS. 1 and 2 illustrate the invention in accordance with various embodiments. FIG. 1 is a perspective view of a tap assembly 2 comprising a tap (not visible) and a cover 4 housing the tap.

The cover 4 comprises a shell with an upper half-shell 4¹ and a lower half-shell 4² which are joined together along a contact plane or plane-like extension 6 that is inclined with regard to a horizontal plane and also with regard to a vertical plane. In other words, the contact plane or plane-like extension 6 forms an angle with a vertical direction which is comprised between 30° and 60°, for example between 40° and 50°.

The cover 4 comprises also a front area part 4³ that is attached to the upper half-shell 4¹. The shell front area part 4³ is located between two lateral arms 8 that extend essentially in vertical planes from the upper half-shell to the handle 10. An outlet connector 12, for instance of the hose barb type, extends through an opening of the shell front area part 4³. A rotating wheel 14 for adjusting the flow rate and/or the pressure of the gas at the outlet 12 is located in another opening of the shell front area part 4³. The wheel 14 comprises a main disk-shaped part 14¹ and a series of ribs 14² extending radially at different location along the periphery of the disk-shaped part 14¹. The shell front area part 4³ comprises a marking 16 at an upper position along the opening that receives the wheel 14. That marking has for instance the shape of an arrow oriented towards the rotation centre of the wheel 14.

An indicator can be placed at the centre of the adjusting wheel 14. Such an indicator can be a pressure gauge, e.g. of the pressure at the inlet of the tap, corresponding to the pressure in the gas cylinder. The indicator can also be an electronic device with a digital display, providing information about the pressure at the inlet and/or outlet, the flow-rate and/or the remaining service time based on the current flow-rate. The wheel 14 can be transparent so as to allow a user to read the indications of the indicator located behind the transparent wheel.

In FIG. 2, the upper half-shell 4¹ and the shell front area part 4³ are illustrated in an exploded view. As is well visible, the shell front area part 4³ comprises a first opening 18 for receiving the adjusting wheel 14 (FIG. 1), and a second opening 20 for receiving the outlet 12 (FIG. 1). The first opening is advantageously sensibly larger than the second one. As is also visible in FIG. 2, the shell front area part 4³ has a general oval shape that fits between the lateral arms 8 holding the handle 10.

The upper half-shell 4¹ comprises an opening 22 whole size corresponds at least approximately to the size of the shell front area part 4³. The upper half-shell 4¹ comprises also at the edge of the opening 22 a shoulder 24 that extends along the majority of the periphery of the opening 22. Several holes 26 for fasting screws can be provided along the opening 22.

The shell front area part 4³ can therefore be easily mounted to the upper half-shell 4¹. It can also be easily replaced by another one of a different design, depending among others of the design of the adjusting wheel, the outlet(s) and the marking that is applied to the outer surface of the part.

The upper and lower half-shells 4¹, 4² and the shell front area part 4³ are in various instances made of plastic material. They are advantageously assembled to each other by means of screws. For instance, the shell front area part 4³ is advantageously fastened to the upper half-shell 4¹ by means of screws that are engaged from inside the cavity of the upper half-shell, so that no fastening means are visible on the outer surface of the shell front area part 4³.

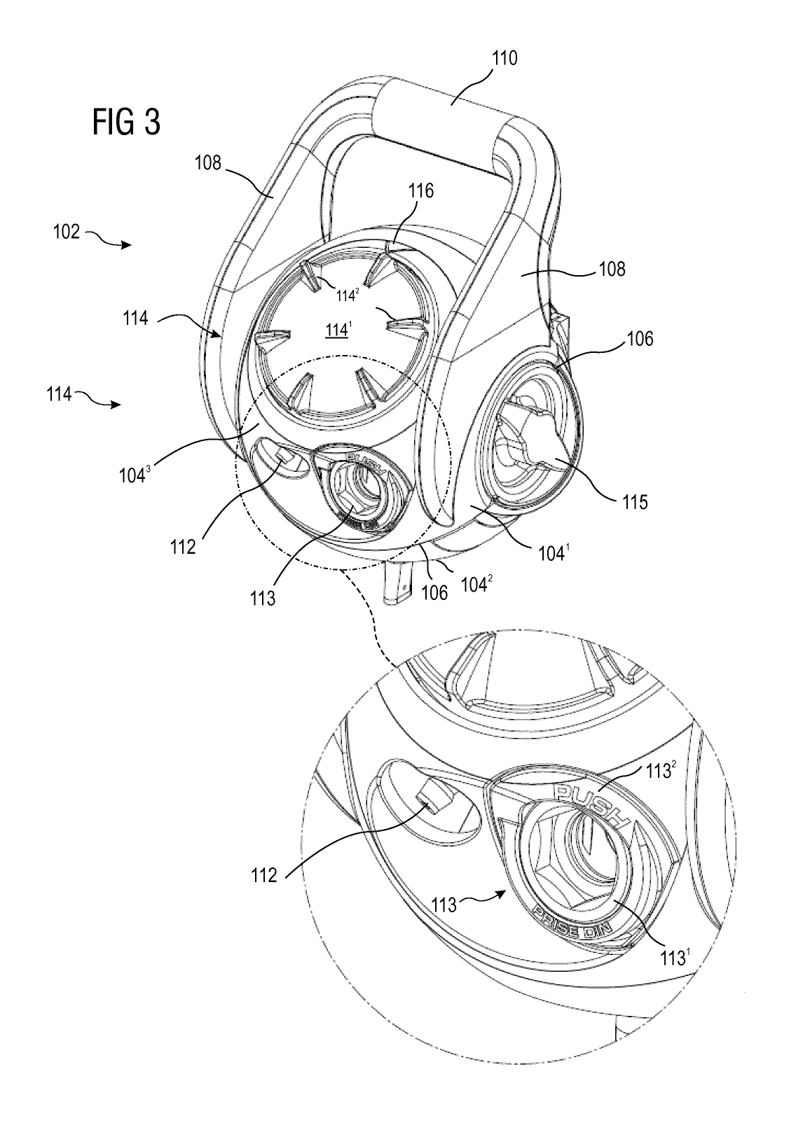

FIGS. 3 to 5 illustrate the invention in accordance with various other embodiments. The reference numbers of the first embodiment in FIGS. 1 and 2 are used here for designating the same or equivalent elements, these numbers being however incremented by 100 for the sake of distinction between the two embodiments. Reference is made to the description of these elements in relation with the first embodiment. Specific numbers comprised between 100 and 200 are used for designating specific elements.

FIG. 3 is a perspective view of a tap assembly 102 comprising a tap (not visible) and a cover 104 housing the tap. The tap assembly 102 differs from the one of FIGS. 1 and 2, essentially in that it comprises a second outlet 113 in the form of a quick connector. The second outlet is located laterally to the first connector 112. It also extends through a specific opening of the shell front area part 104³. As is apparent in the blow-up view of FIG. 3, the connector 113 comprises, essentially, a connector body 113¹ and a ring 113² that is slidably mounted around the connector body 113¹ for releasing the connector. That ring 113² comprises a generally annular surface intended to serve as a push surface, i.e. a surface to be pushed towards the inside of the cover for releasing the connector 113. The push surface of the ring 113², in its normal position, i.e. when not pushed, is generally flush with the surrounding surface of the shell front area part 4³.

The tap assembly 102 differs also from the one of FIGS. 1 and 2 in that it comprises a rotating knob 115 at a lateral side of the cover 104, the knob 115 being for opening and shutting-off the tap. As is visible in FIG. 3, the rotation axis of the knob 115 is at least approximately comprised in the contact plane 106, or plane-like contact extension, between the upper half-shell 104¹ and the lower one 104². This is particularly interesting when assembling the cover 104 on the tap before mounting the resulting assembly to a gas cylinder.

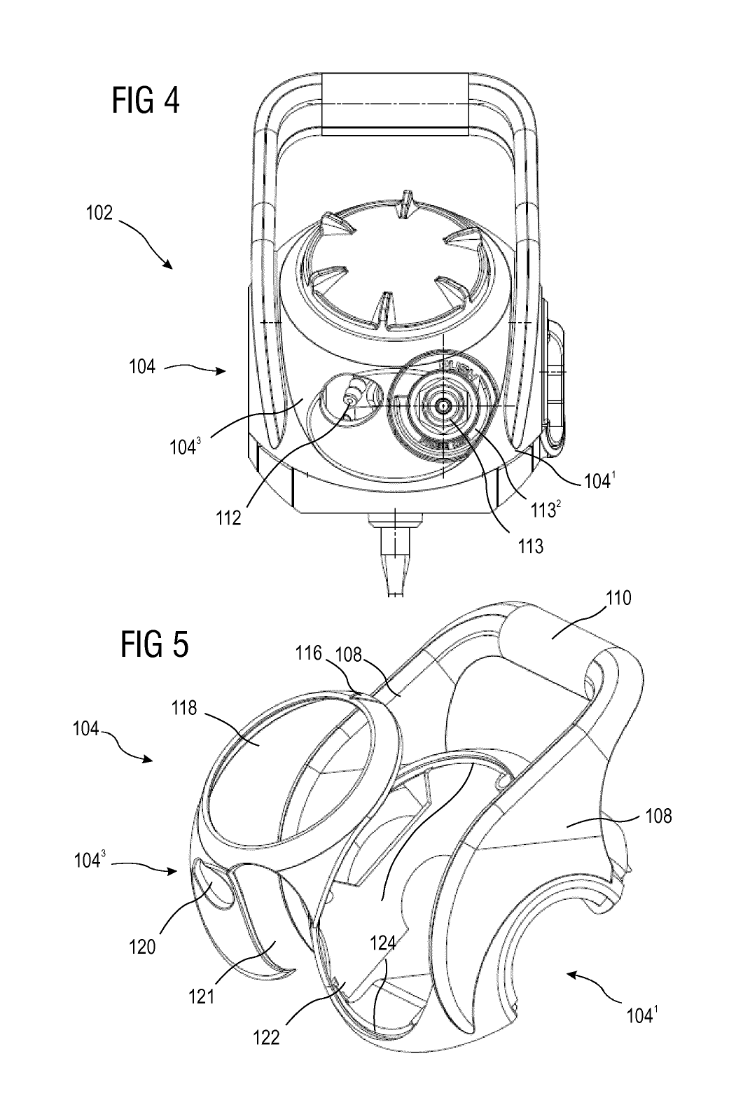

With reference to FIG. 4, the ring 113² of the quick connector 113 is generally circular with however a generally flattened or at least non circular portion that extends along the upper half-shell 104¹. This prevents rotation of the ring 113², thereby keeping the marking on the ring always at the same position. In addition, this provides a sufficiently large push surface on an angular sector of more than 270° while keeping a cover of a reduced size and ergonomic design.

With reference to FIG. 5, the third opening 121 in the shell front area part 104³ has an open contour that allows the flattened portion of the ring 113² to be in contact or at least in front of the corresponding portion of the opening 122 in the upper half-shell 104¹.

1-15. (canceled)

16. A cover for a tap of a gas cylinder, said cover comprising:
a shell for housing the tap, the shell comprising at least one of:
a front area for an indicator;
a wheel for adjusting at least one of an outlet pressure and a flow rate; and
at least one outlet connector of the tap,
wherein the front area of the shell is a part that is distinct from, and configured to be attached to, the rest of the shell.

17. The cover according to claim 16, wherein the shell front area part comprises:
a first opening for receiving the adjusting at least one of the wheel and the indictor;
and at least a second opening for receiving the at least one outlet connector.

18. The cover according to claim 17, wherein the average diameter of the first opening is larger than 150% of the average diameter of the at least one second opening.

19. The cover according to claim 17, wherein the average diameter of the first opening is larger than 200% of the average diameter of the at least one second opening.

20. The cover according to claim 17, wherein the average diameter of the first opening is larger than 300% of the average diameter of the at least one second opening.

21. The cover according to claim 17, wherein the first opening is located above the at least second opening when the cover is in a mounting position on the gas cylinder disposed vertically.

22. The cover according to claim 17, wherein the shell front area part comprises on its outer surface a marking along the first opening, the marking serving as reference for the adjusting wheel.

23. The cover according to claim 16, wherein the shell comprises an upper half-shell and a lower half-shell to be joined to each other, the shell front area part being configured to be located on, and attached to, the upper half-shell.

24. The cover according to claim 23, wherein the upper half-shell and the lower half-shell are configured to be joined together along a general contact plane that forms an angle comprised between 30° and 60° with a vertical direction, and the shell front area part is curved and directed towards a main upward direction that forms an angle comprised between 30° and 60° with a vertical direction, when the cover is in a mounting position on the gas cylinder disposed vertically.

25. The cover according to claim 23, wherein the upper half-shell comprises an opening that corresponds essentially to the shell front area part.

26. The cover according to claim 25, wherein the upper half-shell comprises a shoulder extending along the opening of the upper half-shell, the shell front area part being configured for resting on the shoulder.

27. The cover according to claim 23, wherein the upper half-shell comprises two arms extending laterally and vertically for holding a handle above the shell, the shell front area part being located between the two lateral arms.

28. A tap assembly for a gas cylinder, said tap assembly comprising:
a tap to be screwed on the gas cylinder; and
a cover housing the tap, wherein the cover comprises:
a shell for housing the tap, the shell comprising:
at least one of:
a front area for an indicator;
a wheel for adjusting at least one of an outlet pressure and a flow rate; and
at least one outlet connector of the tap, wherein the front area of the shell is a part that is distinct from, and configured to be attached to, the rest of the shell,
wherein the cover is rigidly attached to the tap so that the tap assembly forms a unit that can be mounted on the gas cylinder.

29. The tap assembly according to claim 28, wherein the tap comprises at least one outlet with a quick connector extending through an opening of the shell front area part, the at least one quick connector comprising a release ring that forms an annular press-surface complementary to the opening.

30. The tap assembly according to claim 29, wherein the shell comprises an upper half-shell and a lower half-shell to be joined to each other, the shell front area part being configured to be located on, and attached to, the upper half-shell, and the annular press-surface is generally circular over more than 270° and comprises, in addition, a flattened portion, the opening in the shell front area part forming an open contour that is complemented by a portion of the upper half-shell, the flattened portion being against the portion of the upper half-shell.

31. The tap assembly according to claim 29, wherein the tap comprises an additional outlet, the outlet comprising a hose barb connector extending through another opening of the shell front area part.

32. The tap assembly according to claim 28, wherein the tap comprises a shut-off valve with an actuating knob at a lateral location of the shell.
